(19) United States
(12) Patent Application Publication
(10) Pub. No.: US 2008/0153514 A1
(43) Pub. Date: Jun. 26, 2008

(54) Apparatus and method for providing real-time information in portable communication system

(75) Inventor: Hwa-Seong Nam, Seoul (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/999,499

(22) Filed: Dec. 4, 2007

(30) Foreign Application Priority Data
Dec. 4, 2006 (KR) 2006-0121324

(51) Int. Cl. H04Q 7/20

(52) U.S. Cl. 455/456.3

(57) ABSTRACT

Provided are an apparatus and a method for identifying a position information of a portable terminal using a mobile communication network and obtaining provincial information (e.g., meteorological information, traffic information, etc.) corresponding to the identified position information through a broadband communication network in a multimode portable communication system supporting access to the mobile communication network and the broadband communication network.

### PRIORITY

This application claims priority under 35 U.S.C. § 119 to an application entitled “Apparatus and method for providing real-time information in portable communication system” filed in the Korean Intellectual Property Office on Dec. 4, 2006 and assigned Serial No. 2006-121324, the contents of which are incorporated herein by reference.

### BACKGROUND OF THE INVENTION

1. Field of the Invention

The present invention relates generally to an apparatus and a method for identifying real time information using a portable communication system, and in particular, to an apparatus and a method for identifying a position of a multimode portable communication system using a mobile communication network and requesting real time information such as meteorological information corresponding to the identified position through a broadband communication network in the multimode portable communication system supporting the mobile communication network and the broadband communication network.

2. Description of the Related Art

Portable communication systems are necessary for modern people and thus used by people of all ages. Service providers and system manufacturers have competitively developed products (or services) to differentiate their products (or services) from those of other enterprises.

For example, portable communication systems have developed into multimedia systems which store a phonebook, play games, transmit and/or receive short messages and e-mails, and provide the functions of a morning or wake-up call, MPEG Layer 3 (MP3), a digital camera, and a wireless Internet service, so as to provide various services.

The wireless Internet service allows a user using the portable communication system to easily use the Internet when the user is not able to use a personal computer while on the move. Thus, many users use the wireless Internet service.

For example, if a user desires to check meteorological information while moving, the user may access contents providing the meteorological information using a wireless Internet function of the portable communication system to check the meteorological information.

However, the user must access the contents providing the meteorological information and then directly select an area in which the user desires to check the meteorological information. Also, the user may check meteorological information of a wide area.

In other words, the user must access the contents providing the meteorological information and then select an area or city (e.g., Seoul) from an area or city list (Seoul, Gyeonggi-do, Chungcheongnam-do, Chungcheongbuk-do, Gyeongsangnam-do, Gyeongsangbuk-do, etc.). However, the user cannot check meteorological information of a specific area (e.g., Gwangwhamun, Jongno, Seodaemun, etc.).

Also, since the user accesses the contents providing the meteorological information through a mobile communication network, the user must pay a high fee to use the mobile communication network.

### SUMMARY OF THE INVENTION

An aspect of the present invention is to substantially solve at least the above problems and/or disadvantages and to provide at least the advantages below. Accordingly, an aspect of the present invention is to provide an apparatus and a method for identifying meteorological information using a multimode portable communication system.

Another aspect of the present invention is to provide an apparatus and a method for logging into a server providing meteorological information through a broadband communication network to check the meteorological information in a multimode portable communication system.

A further aspect of the present invention is to provide an apparatus and a method for identifying a position of a multimode portable communication system through a mobile communication network and requesting meteorological information corresponding to the position of the multimode communication system in the multimode portable communication system.

The above aspects are achieved by providing a point-to-point emulation apparatus and method in a broadband wireless communication system.

According to one aspect of the present invention, there is provided a portable communication system for identifying provincial information, including a portable terminal identifying a position of the portable terminal through a mobile communication network and performing a connection to a provincial information server through a broadband communication network so as to be provided with the provincial information from the provincial information server; and the provincial information server obtaining provincial information corresponding to a request of the portable terminal and transmitting the provincial information to the portable terminal.

According to another aspect of the present invention, there is provided a method of identifying provincial information in a portable communication system supporting accesses to at least two different networks, including identifying a position of a portable terminal using Base Station (BS) information received through a mobile communication network; accessing a provincial information server providing provincial information through a broadband communication network; and transmitting the position of the portable terminal to the provincial information server through a broadband communication network to request the provincial information.

According to a further aspect of the present invention, there is provided a method of providing provincial information corresponding to a request of a portable terminal through a provincial information server providing provincial information, including if a connection to the portable terminal is performed through a broadband communication network, and then position information is received from the portable terminal, obtaining provincial information corresponding to the position information; and transmitting the obtained provincial information to the portable terminal.

According still another aspect of the present invention, there is provided a portable terminal for identifying provincial information, including a mobile communicator receiving Base Station (BS) information for identifying a position of the portable terminal; a broadband communicator transmitting the identified position to a provincial information server providing the provincial information and receiving provincial information from the provincial information server; and a Micro-Processor Unit (MPU) identifying the position of the portable terminal using the BS information received through the mobile communicator and performing a connection to the server through the broadband communicator to receive the provincial information.

### BRIEF DESCRIPTION OF THE DRAWINGS

The above and other objects, features and advantages of the present invention will become more apparent from the following detailed description when taken in conjunction with the accompanying drawings in which:

FIG. 1 is a block diagram of a multimode portable communication system according to the present invention;

FIG. 2 is a flowchart of a process of identifying real-time meteorological information in a portable terminal, according to the present invention; and

FIG. 3 is a flowchart of a process of providing meteorological information corresponding to a request of a portable terminal through a meteorological information server, according to the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

The present invention provides an apparatus and a method for identifying a position of a multimode portable communication system through a mobile communication network and receiving provincial information through a heterogeneous network in the multimode portable communication system supporting access to two different networks, i.e., the mobile communication network and the heterogeneous network.

Here, “provincial information” refers to real-time information (e.g., meteorological information, traffic information, map information, etc.) corresponding to an area in which the multimode portable communication system is positioned. Hereinafter, meteorological information will be described as an example of the provincial information.

The heterogeneous network includes all types of networks except for a mobile communication network. A broadband network, e.g., a Wireless Broadband Internet (WiBro), or a High Speed Downlink Packet Access (HSDPA) will be described as an example of the heterogeneous network.

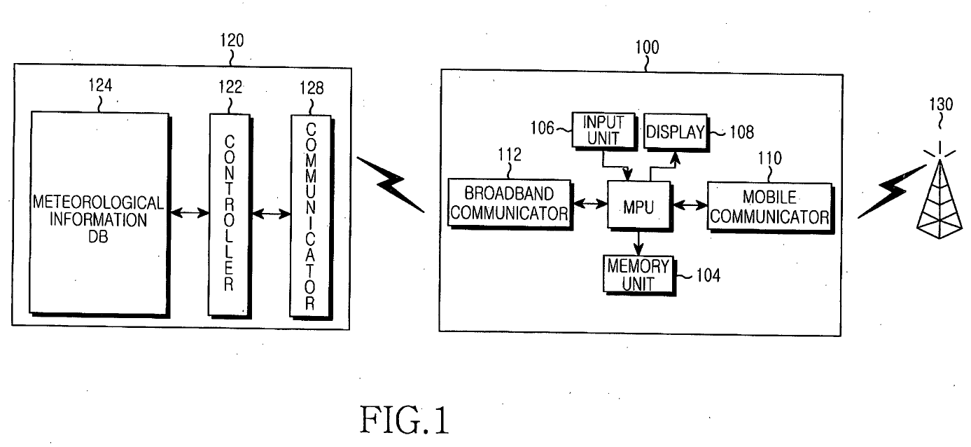

FIG. 1 is a block diagram of a multimode portable communication system providing meteorological information according to the present invention.

Referring to FIG. 1, the multimode portable communication system includes a portable terminal 100, a meteorological information server 120, and a wireless Base Station (BS) 130.

The portable terminal 100 includes a Micro-Processor Unit (MPU) 102, a memory unit 104, an input unit 106, a display 108, a mobile communicator 110, and a broadband communicator 112.

The MPU 102 controls an overall operation of the portable terminal 100. For example, the MPU 102 performs processing and controlling for voice and data communications. According to the present invention, besides the normal functions, if a meteorological information check event occurs, the MPU 102 receives BS information from the wireless BS 130 through a mobile communication network to check a position of the portable terminal 100.

Next, the MPU 102 communicates with the meteorological information server 120 providing the meteorological information using a broadband communication network and then transmits information as to the position of the portable terminal 100 to request meteorological information corresponding to the position of the portable terminal 100.

The MPU 102 also receives the meteorological information from the meteorological information server 120 and outputs the meteorological information to the display 108.

The memory unit 104 includes a read only memory (ROM), a random access memory (RAM), and a flash ROM. The ROM stores micro-codes of a program for a controlling operation of the MPU 102 and various types of reference data.

The RAM is a working memory of the MPU 102 and stores temporal data generated during the execution of various programs. The flash ROM stores various types of updatable storage data including a phonebook, transmitted messages, and received message.

The input unit 106 includes a plurality of function keys such as numerical key buttons from “0” to “9,” a menu button, a cancel (delete) button, a confirm button, a talk (send) button, an end button, an Internet connection button, navigation (direction) key buttons, a character input key button, etc. The input unit 106 provides the MPU 102 with key input data corresponding to a key pressed by a user.

The display 108 displays state information, limited numerical characters, moving pictures, still pictures, etc. generated during operations of the portable terminal 100. The display 108 may be a color Liquid Crystal Display (LCD).

The mobile communicator 110 transmits and receives radio frequency (RF) signals of data input and output through an antenna (not shown). For example, the mobile communicator 110 performs channel coding and spreading on data to be transmitted, converts the data into an RF signal, and transmits the RF signal during transmission. The mobile communicator 110 transforms a received RF signal into a baseband signal and performs dispreading and channel decoding on the baseband signal to restore the RF signal to original data during receipt. The mobile communicator 110 also receives the BS information necessary for identifying the position of the portable terminal 100 from the wireless BS 130.

The broadband communicator 112 RF-communicates with a broadband communication network to log into the Internet. According to the present invention, the broadband communicator 112 is connected to the meteorological information server 120 to transmit the information regarding the position of the portable terminal 100 to the meteorological information server 120 so as to request the meteorological information corresponding to the position of the portable terminal 100. The broadband communicator 112 also receives the meteorological information from the meteorological information server 120.

The meteorological information server 120 includes a controller 122, a communicator 128, and a meteorological information database (DB) 124.

The controller 122 of the meteorological information server 120 performs an overall operation of the meteorological information server 120. According to the present invention, if a request for the meteorological information is received from the portable terminal 100, the controller 122 searches the meteorological information DB 124 for the meteorological information and transmits the meteorological information corresponding to the position of the portable terminal 100 to the portable terminal 100.

The communicator 128 communicates with the portable terminal 100 and receives the request for the meteorological information from the portable terminal 100.

The communicator 128 transmits the meteorological information to the portable terminal 100.

The meteorological information DB 124 includes meteorological information of each area.

The wireless BS 130 communicates with the portable terminal 100 to transmit the BS information for identifying the position of the portable terminal 100 to the portable terminal 100.

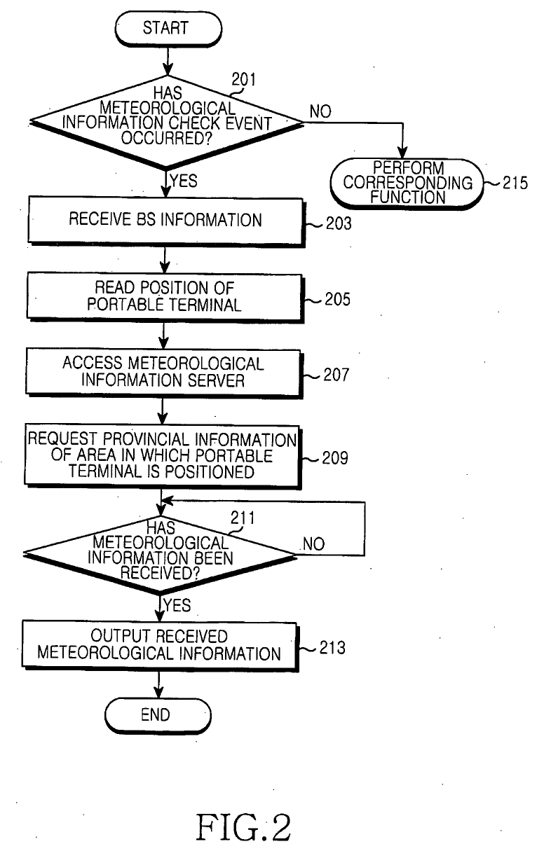

The multimode portable communication system for identifying meteorological information has been described. A method of identifying the meteorological information, one of a plurality of different types of provincial information, using the portable terminal 100 according to a preferred embodiment of the present invention will now be described with reference to the flowchart of FIG. 2.

Referring to FIG. 2, in step 201, the MPU 102 of the portable terminal 100 determines whether a meteorological information check event has occurred from a user. If it is determined in step 201 that the meteorological information check event has not occurred, the MPU 102 goes to step 215 to perform a corresponding function, e.g., a standby mode.

If it is determined in step 201 that the meteorological information check event has occurred, the MPU 102 proceeds to step 203 to receive BS information from the wireless BS 130.

Here, the wireless BS 130 may transmit the BS information to the portable terminal 100 at predetermined time intervals or whenever the wireless BS 130 senses a request for the BS information from the portable terminal 100.

The wireless BS 130 may transmit the BS information to the portable terminal 100 through a paging channel.

In step 205, the MPU 102 reads a position of the portable terminal 100 using the BS information. In step 207, the MPU 102 performs a connection to the meteorological information server 120.

Here, the connection to the meteorological information server 120 may be performed through a broadband network, e.g., a Wireless Broadband Internet (WiBro), a High Speed Downlink Packet Access (HSDPA), or the like. A user can receive the meteorological information at a lower fee using the broadband network than when using the mobile communication network.

In step 209, the MPU 102 transmits the read position of the portable terminal 100 to the meteorological information server 120 to request meteorological information of an area in which the portable terminal 100 is positioned.

For example, if the MPU 102 determines using the BS information that the portable terminal 100 is positioned in area A, the portable terminal 100 may request meteorological information of the area A of the meteorological information server 120. The position of the portable terminal 100 refers position information of an area (e.g., Seodaemun, Jongno, Gwangwhamun, etc.) which is measured using the BS information and more detailed than position information (e.g., Seoul, Gyeonggi-do, Chungcheongnam-do, etc.) necessary for providing normal meteorological information.

In step 211, the MPU 102 determines whether meteorological information corresponding to the requested area has been received from the meteorological information server 120. If it is determined in step 211 that the meteorological information has not been received from the meteorological information server 120, the MPU 102 repeats step 211.

If it is determined in step 211 that the meteorological information has been received from the meteorological information server 120, the MPU 102 proceeds to step 213 to output the meteorological information to the display 108 of the portable terminal 100.

The MPU 102 then ends the present process.

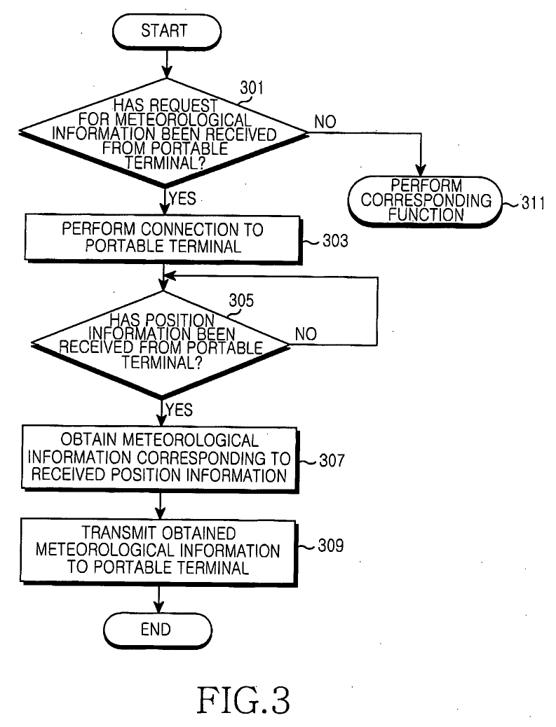

FIG. 3 is a flowchart of a process of providing meteorological information corresponding to a request of a portable terminal through a meteorological information server, according to the present invention.

Referring to FIG. 3, in step 301, the controller 122 of the meteorological information server 120 determines whether a request for meteorological information has been received from the portable terminal 100. If it is determined in step 301 that the request for meteorological information has not been received from the portable terminal 100, the controller 122 of the meteorological information server 120 goes to step 311 to perform a corresponding function, e.g., a standby mode.

If it is determined in step 301 that the request for meteorological information has been received from the portable terminal 100, the controller 122 of the meteorological information server 120 proceeds to step 303 to perform a connection to the portable terminal 100.

In step 305, the controller 122 determines whether position information has been received from the portable terminal 100. If it is determined in step 305 that the position information has not been received from the portable terminal 100, the controller 122 repeats step 305.

If it is determined in step 305 that the position information has been received from the portable terminal 100, the controller 122 proceeds to step 307 to search the meteorological information DB 124 so as to obtain meteorological information corresponding to the position information received from the portable terminal 100.

In step 309, the controller 122 transmits the meteorological information to the portable terminal 100. The controller 122 then ends the present process.

In accordance with the present invention as described above, in order to check provincial information using a multimode portable communication system supporting a broadband communication network, a position of the multimode portable communication system can be identified through a mobile communication network. Also, a connection to a server providing the provincial information can be performed through the broadband communication network. Thus, real-time information can be provided at a lower fee than when being provided with real-time information using an existing mobile communication network.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A portable communication system for identifying provincial information, comprising:
a portable terminal identifying position information of the portable terminal through a mobile communication network and transmitting the position information of the portable terminal through a broadband communication network; and
a provincial information server receiving the position information of the portable terminal from the portable terminal and transmitting the provincial information corresponding to the received position information of the portable terminal to the portable terminal through the broadband communication network.

2. The portable communication system of claim 1, wherein the portable terminal comprises:
a mobile communicator receiving information of a Base Station (BS) covering an area in which the portable terminal is positioned for identifying the position information of the portable terminal;
a micro-processor unit (MPU) identifying the position information of the portable terminal using the received BS information; and
a broadband communicator transmitting the position information to the provincial information server and receiving the provincial information from the provincial information server through the broadband communication network.

3. The portable communication system of claim 2, wherein if the MPU receives the provincial information through the broadband communicator, the MPU outputs the provincial information.

4. The portable communication system of claim 1, wherein the provincial information server comprises:
a communicator receiving the position information of the portable terminal and transmitting the provincial information corresponding to the position information to the portable terminal;
a provincial information database (DB) comprising the provincial information corresponding to each position information; and
a controller searching the provincial information DB if the position information is received from the portable terminal to obtain the provincial information corresponding to the position of the portable terminal.

5. The portable communication system of claim 1, wherein the provincial information is provided in real time depending on the position of the portable terminal, and the provincial information comprises at least one of meteorological information, map information, and traffic information corresponding to the position information of the portable terminal.

6. The portable communication system of claim 1, wherein the broadband communication network comprises at least one of a Wireless Broadband Internet (WiBro) and a High Speed Downlink Packet Access (HSDPA).

7. A portable terminal for obtaining provincial information, comprising:
a mobile communicator receiving information of a Base Station (BS) covering an area in which the portable terminal is positioned through a mobile communication network;
an micro-processor unit (MPU) identifying a position information of the portable terminal using the received BS information; and
a broadband communicator transmitting the position information of the portable terminal to a provincial information server through a broadband communication network and receiving a provincial information corresponding to the position information from the provincial information server through the broadband communication network.

8. The portable terminal of claim 7, wherein the provincial information is provided in real time depending on the position information of the portable terminal, and the provincial information comprises at least one of meteorological information, map information, and traffic information corresponding to the position information of the portable terminal.

9. The portable terminal of claim 7, wherein the broadband communication network comprises at least one of a WiBro and a HSDPA.

10. A method of obtaining provincial information in a portable communication system supporting access to at least two different networks, comprising:
identifying position information of the portable terminal using information of a Base Station (BS) covering an area in which the portable terminal is positioned received through a mobile communication network;
accessing a provincial information server through a broadband communication network; and
transmitting the position information of the portable terminal to the provincial information server through the broadband communication network to request the provincial information corresponding to the position information of the portable terminal.

11. The method of claim 10, further comprising the steps of;
receiving the provincial information from the provincial information server from the provincial information server; and
outputting the received provincial information.

12. The method of claim 10, wherein the provincial information is provided in real time depending on the position information of the portable terminal, and the provincial information comprises at least one of meteorological information, map information, and traffic information corresponding to the position information of the portable terminal.

13. The method of claim 10, wherein the broadband communication network comprises at least one of a Wireless Broadband Internet (WiBro) and a High Speed Downlink Packet Access (HSDPA).

14. A method of providing provincial information corresponding to a request of a portable terminal through a provincial information server providing provincial information, comprising:
if a connection to the portable terminal is performed through a broadband communication network, and then position information which is obtained by the portable terminal through a mobile communication network is received from the portable terminal, obtaining provincial information corresponding to the position information; and
transmitting the obtained provincial information to the portable terminal through the broadband communication network.

15. The method of claim 14, wherein the provincial information is provided in real time depending on the position information of the portable terminal, and the provincial information comprises at least one of meteorological information, map information, and traffic information corresponding to the position information of the portable terminal.

16. The method of claim 14, wherein the broadband communication network comprises at least one of a Wireless Broadband Internet (WiBro) and a High Speed Downlink Packet Access (HSDPA).

17. An apparatus for obtaining provincial information in a portable terminal, comprising:
means for identifying position information of the portable terminal using information of a Base Station (BS) covering an area in which the portable terminal is positioned received through a mobile communication network; and
means for transmitting the position information of the portable terminal to a provincial information server through a broadband communication network to request the provincial information corresponding to the position information of the portable terminal.
